(19) United States
(12) Patent Application Publication
(10) Pub. No.: US 2011/0286824 A1
(43) Pub. Date: Nov. 24, 2011

(54) Device for Collecting Objects from a Roadway

(75) Inventor: Jean-Luc Staebler, Chambry (FR)

(73) Assignee: SANEF, Paris (FR)

(21) Appl. No.: 13/127,805

(22) PCT Filed: Nov. 2, 2009
(86) PCT No.: PCT/FR2009/001268

§ 371 Date: Aug. 15, 2011

(30) Foreign Application Priority Data
Nov. 5, 2008 (FR) 0806176
Dec. 24, 2008 (FR) 0807455

(51) Int. Cl. B60P 1/04

(52) U.S. Cl. 414/480

(57) ABSTRACT

The invention relates to a device (1) for collecting objects (2) from a roadway (3) and to a van-type vehicle provided with such a device, comprising a collecting plate (10), means for fixing (11) said plate to a motorised land vehicle (4), and actuating means (12) for moving the plate from a non-operational lifted position to a lowered collecting position and vice versa, said fixing means being used to fix the collecting plate to a front end of a motorised land vehicle. The invention is characterised in that the actuating means are suitable for pivoting the collecting plate between the lifted position in which it is perpendicularly oriented to the surface of the roadway, and the lowered position in which it is essentially parallel to the surface of the roadway. The invention also relates to a van-type vehicle (4) comprising such a device.

The invention relates to a device for collecting articles on a roadway, and to a van type vehicle fitted with such a device.

Articles lying on the surface of a road or freeway constitute a major danger for traffic. Such articles include in particular fragments of burst tires, hubcaps, goods that have fallen off vehicles transporting them, etc.

In general, such articles are collected manually by an operative (a patrolman) going to the site on board a vehicle, parking said vehicle on the roadside or on the emergency hard shoulder of a freeway, leaving the vehicle, and crossing the roadway on foot. That operation runs the risk of the operative colliding with vehicles traveling on the lanes of a freeway or a road, and from time to time can give rise to accidents leading to severe injuries or death of the operative.

Document US 2006/0145489 teaches that it is possible to collect articles from a roadway using a front-end loader with its bucket having a pad of resilient material fitted to its bottom portion in order to come into contact with the surface of the roadway. Nevertheless, the thickness of the pad constitutes an obstacle to effective collection of articles. Furthermore, a front-end loader generally travels much more slowly than other vehicles traveling on a freeway, thereby constituting an impediment or even a danger to traffic.

Documents U.S. Pat. No. 5,596,784 and U.S. Pat. No. 5,745,947 disclose vehicles that are specially adapted to collecting articles on a roadway. Those machines are complex and expensive. Specifically, the operator of a road or freeway network would have only a very limited number of such machines and would therefore not be in a position to respond quickly once an article is reported on a roadway. Speed of response is essential for ensuring the safety of users of the network.

Document KR 2002/0082034 discloses a device for collecting articles on a roadway, the device comprising a collector tray for mounting under a motor vehicle, together with actuator means enabling said tray to be moved in vertical translation from a non-operational, raised position to a collecting, lowered position, and vice versa. Such a device presents the drawback of being suitable for being installed solely on a vehicle of the heavy goods vehicle type: the ground clearance of a light vehicle would not be sufficient to enable such a collector tray to be mounted and moved vertically, without excessively sacrificing the dimensions of the tray, and thus the dimensions of articles that can be collected. That document thus suffers, although in less marked manner, from one of the drawbacks mentioned with respect to documents U.S. Pat. No. 5,596,784 and U.S. Pat. No. 5,745,947, namely the difficulty of having a fleet of sufficient collector vehicles making it possible to respond quickly at any point on a road or freeway network.

The invention seeks to solve the above-mentioned drawbacks of the prior art.

According to the invention, this object is achieved by a device for collecting articles on a roadway, the device comprising a collector tray, fastener means for fastening said tray to a land motor vehicle, and actuator means for causing said tray to move from a non-operational, raised position to a collecting, lowered position, and vice versa, the device being characterized in that: said fastener means are adapted to enable said collector tray to be fastened directly to the front of a land motor vehicle; and in that said actuator means are adapted to cause said collector tray to pivot between said raised position in which it is oriented perpendicularly to the surface of the roadway, and said lowered position in which it is substantially parallel to the surface of the roadway.

Since the collector tray is mounted at the front of the vehicle, and not under the vehicle, the vehicle may be a light vehicle without it being necessary to sacrifice the capacity of the tray. It is thus possible to mount a collector device of the invention on all of the vans used by the patrolmen of a section of freeway, thereby enabling responses to be extremely fast.

In addition, the collector tray of the device in document KR 2002/0082034 projects from the front of the vehicle when it is in its raised position. That arrangement is clearly dangerous for other users of the road, in particular in the event of a collision. The device of the invention does not present that drawback.

In particular embodiments of the invention:

The collector device may also include a detector for measuring the distance between the collector tray and the roadway, and a servo-control system for maintaining said distance constant when the tray is in its collecting, lowered position. Typically a distance of about 1 centimeter (cm) is appropriate.

Said collector tray may include at least one wheel for coming into contact with the roadway when the tray is in its collecting, lowered position.

In a variant, said collector tray may be arranged in such a manner that when it is in its operating, lowered position, at least a front portion of its bottom rubs against the roadway.

The collector tray may include at least two flaps forming a funnel for guiding articles to be collected towards the inside of said tray. Advantageously, said flaps may be pivotally mounted to pass from a folded position when the collector tray is in its non-operational, raised position, to an unfolded position when the collector tray is in its collecting, lowered position. The device of document KR 2002/0082034 does not present such a funnel, and it would be difficult for one to be housed under the vehicle without running the risk of coming into contact with the vehicle wheels.

The collector tray may be fitted with a brushing roll fastened to its top portion.

In a variant, or in addition, the collector tray may be fitted with at least one abutment situated in its front portion, and pivotally mounted in such a manner as to enable an article to enter into the tray but to prevent it from leaving the tray accidentally.

Said actuator means may be adapted to enable the collector tray to pivot and/or move sideways in translation when it is in its collecting, lowered position. This makes it possible in particular to use the collector tray to push to the side of the road an article that is too large to be collected. Once more, this characteristic would be incompatible with the collector tray being fastened under the vehicle.

The collector tray may be provided with means for absorbing the kinetic energy of collected articles and for preventing them from being expelled from said tray.

The collector tray may be provided with a top closure element, preferably a resilient element. Advantageously, said top closure element may be mounted to move in translation on the collector tray in such a manner as to approach the bottom of said tray as it passes into its raised position and to move away from said bottom as the tray passes into its lowered position.

The invention also provides a land motor vehicle of the van type including such a device for collecting articles on a roadway, together with control means for controlling the actuators of said device. Advantageously, the article collector tray may be fastened between the headlights of the vehicle in such a manner as to be positioned in front of the radiator grille of the vehicle when in its raised position.

Other characteristics, details, and advantages of the invention appear on reading the description made with reference to the accompanying drawings given by way of example and in which:

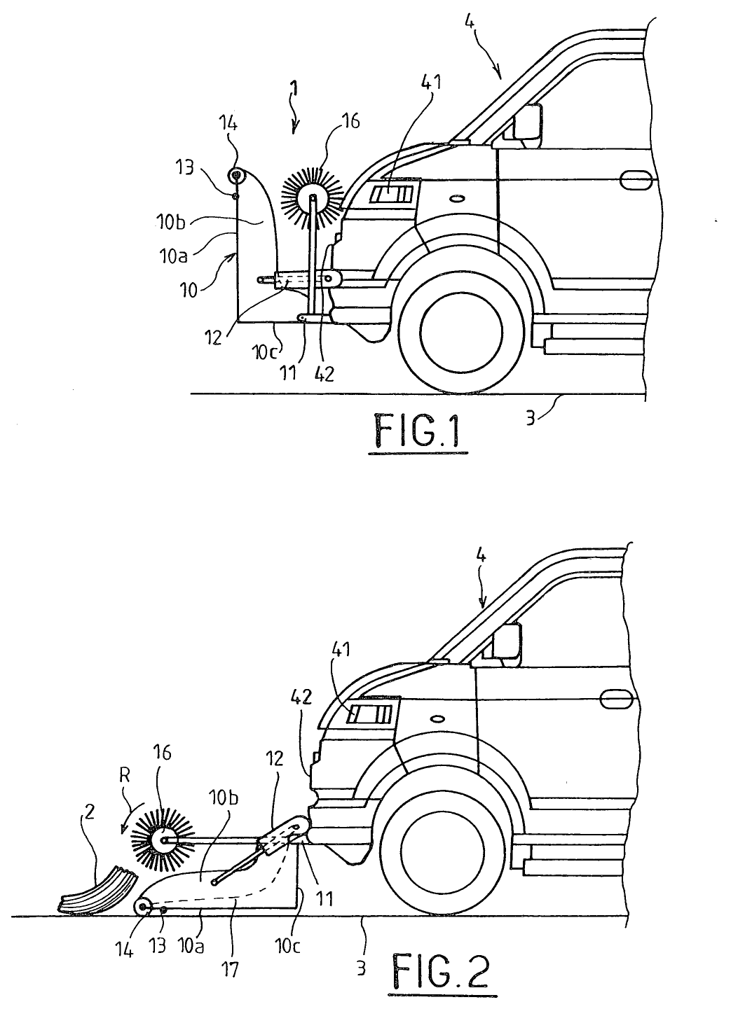

FIG. 1 is a side view of the front portion of a van fitted with a collector device in a first embodiment of the invention shown in its non-operational, raised position;

FIG. 2 is a side view of the front portion of a van fitted with a collector device in said first embodiment of the invention, shown in its collecting, lowered position;

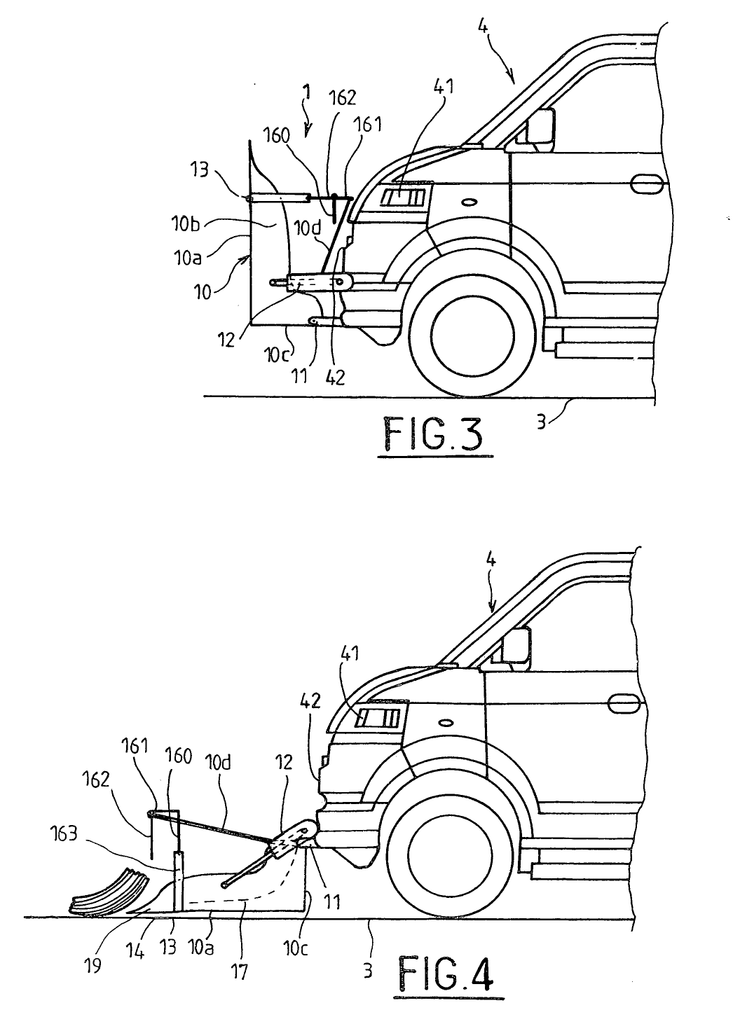

FIG. 3 is a side view of the front portion of a van fitted with a collector device in a second embodiment of the invention, shown in its non-operational, raised position;

FIG. 4 is a side view of the front portion of a van fitted with a collector device in said second embodiment of the invention, shown in its collecting, lowered position;

FIG. 5 is a plan view of the front portion of the FIG. 4 van;

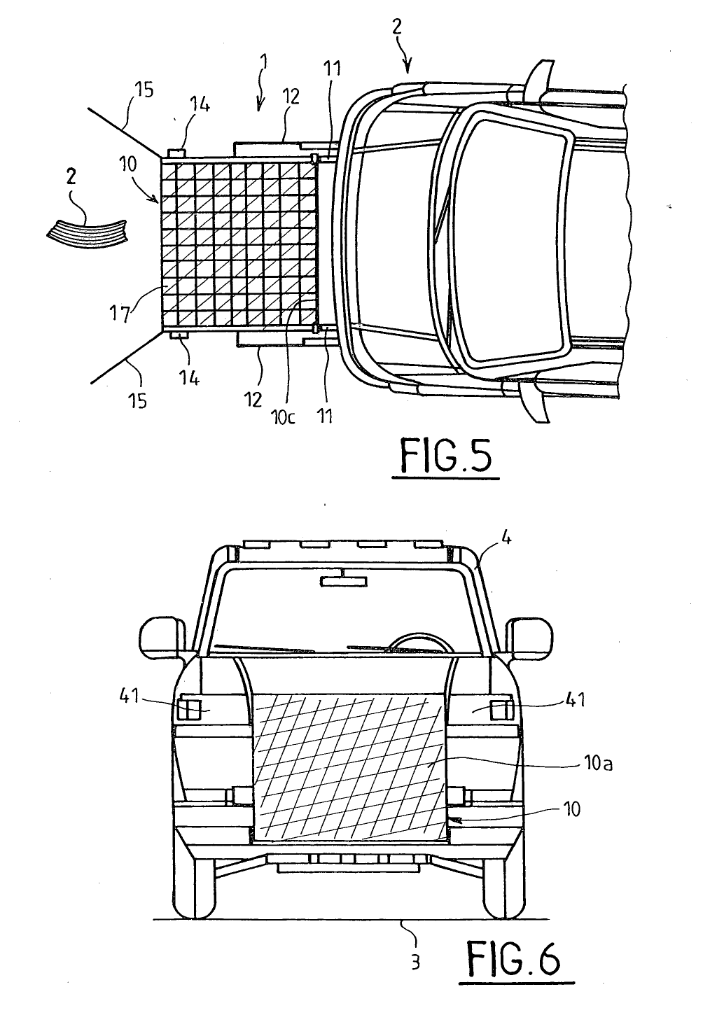

FIG. 6 is a front view of the FIG. 4 van with the collector tray in the raised position; and

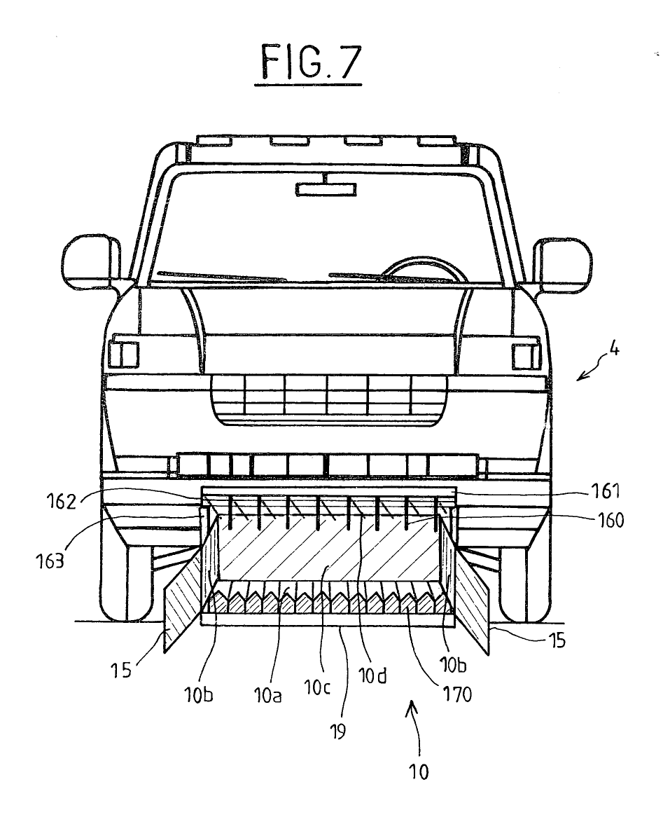

FIG. 7 is a front view of the FIG. 4 van with the collector tray in the lowered position.

The article collector device 1 of the invention comprises a collector tray 10 having a bottom 10a, two side rims or flanks 10b, an end wall 10c, and an optional top closure element 10d for the tray. A net 17 may be tensioned over the bottom 10a and in front of the end wall 10c so as to absorb the kinetic energy of collected articles and prevent them from bouncing, and thereby being ejected out from the tray. This enables collection to be performed at a relatively high speed, of the order of 50 kilometers per hour (km/h) to 60 km/h, or more. Other kinetic energy absorber means, such as foam padding, could also be envisaged.

The top closure element 10d may be constituted by a cover, or more advantageously by a net constituted by resilient cables and/or resilient straps. It is advantageous for the distance between the top closure element 10d and the bottom 10a of the collector tray 10 to be variable. In particular, when the tray pivots towards its raised position, said top closure element may move towards the bottom in order to minimize the space occupied by the device; conversely, when the tray pivots towards its lowered position, said element may move away from the bottom in order to enable articles of large dimensions to be collected. This movement may be controlled by actuators, or it may preferably be obtained in passive manner by means of resilient elements such as springs.

In a first embodiment of the invention (FIGS. 1 and 2), a brushing roll 16 may be located above the collector tray 10, being supported by two arms extending parallel to the bottom 10a. These arms may be adapted to enable the brushing roll 16 to move vertically through a certain distance relative to the bottom 10a of the tray, in order to enable articles of large dimensions to be collected.

In FIG. 2, arrow R indicates the direction of rotation of the brushing roll under drive from an electric motor, thereby making it easier to collect an article 2 lying on the roadway 3, and preventing it from being expelled accidentally from the tray 10.

In a second embodiment of the invention (FIGS. 3 to 7), the brushing roll 16 is replaced by an abutment or a set of pivoting abutments situated at the front of the tray and enabling articles to enter into said tray but preventing them from leaving it.

In the example of FIGS. 3 to 7, the set of abutments is constituted by a plurality of rods 160 pivoting about a horizontal axis and mounted on a horizontal bar 161 extending across the tray. The rods 160 are free to pivot rearwards when the tray is raised (see FIG. 3) or when an article is collected; in contrast, their forward pivoting is limited so as to prevent an article contained in the tray escaping accidentally (see FIGS. 4 and 7). It will be understood that the rods 160 could be replaced by abutments of some other shape, e.g. plates; the abutments could also be hinged to the bottom of the tray or to its flanks, and they could include a resilient return element, such as a spring.

FIG. 7 shows a set of pivoting abutments 170 in the form of teeth that operate as non-return teeth that are hinged to the bottom of the tray. They serve in particular to prevent articles of small dimensions escaping from the tray by passing under the rods 160.

The horizontal bar 161 does not support only the abutments 160, but also the front end of the resilient net 10d constituting the top closure element of the tray 10.

In FIGS. 3, 4, and 7, it can be seen that the horizontal bar 161 is carried by two vertical bars 162 slidably mounted in guides 163; springs situated inside the guides serve to urge the vertical bars 162 outwards. When the tray is in its raised position, the vertical bars 162 are forced into the guides 163 against the action of the springs: this serves to minimize the space occupied by the device. Conversely, when the tray is in its lowered position, said springs push the vertical bars 162 out from the guides, thereby moving the horizontal bar 161 and the top closure element away from the bottom of the tray so as to maximize its opening and allow it to collect articles of large dimensions.

The assembly comprising the bar 161 and the rods 160 is not shown in FIGS. 5 and 6 for reasons of clarity. Likewise, the energy-absorber net 17 is not shown in FIGS. 5 and 7 so as to avoid overcrowding the figures.

The collector tray 10 is fastened to the front portion of a land motor vehicle 4, such as van, via two hinges 11 that enable it to pivot about a horizontal axis extending perpendicularly to the forward travel direction of the van 4. This pivoting is controlled by two hinged hydraulic actuators 12, each connected at one end to the van 4 and at the opposite end to a respective one of the flanks 10b of the tray. Advantageously, the hinges 11 may be elastomer bearings, commonly referred to as “silent blocks”, so as to attenuate the vibration and impacts due to irregularities of the roadway, for example.

As shown in FIGS. 1 and 4, when the actuators 12 are in their retracted state, the tray 10 is oriented vertically and is positioned between the headlights 41 of the vehicle 4, in front of its radiator grille 42. This is the non-operational position of the device; and it may be observed that the tray 10, when in this position, does not constitute a danger for other vehicles.

Extending the actuators 12 brings the tray 10 into its collecting, lowered position, in which the bottom 10a extends parallel to the roadway 3 at a height above the roadway lying in the range a few millimeters to a few centimeters. A sensor 13, e.g. an ultrasound sensor, together with a servo-control system (not shown) may be provided for maintaining the distance between the tray 10 and the roadway 3 constant.

One or more “jockey” wheels 14 (absent from the embodiment of FIGS. 3 to 7) may be provided to ensure that the bottom 10a of the collector tray does not come into contact with the roadway 3, even when said tray is loaded with articles it has collected.

In a variant, shown in particular in FIG. 4, the collector tray may be mounted in such a manner that in its lowered position a front end 19 of its bottom, advantageously in the form of a blade that presents sufficient mechanical strength, rubs against the roadway in order to facilitate collecting articles by a scraping action. Under such circumstances, it is generally not necessary for wheels 14 to be present.

In the example of FIG. 4, the assembly comprising the bar 161 and the rods 160 is situated in front of the scraper blade 19 so as to prevent any articles lying on the roadway being projected upwards.

As shown in FIGS. 5 and 7, flaps 15 may be provided at the front of the tray 10 so as to form a funnel for directing articles situated at the sides towards the collector device. Advantageously, these flaps may be pivotally mounted so as to fold along the flanks 10b or across the front opening of the tray when the tray is in the non-operational (raised) position. The pivoting of the flaps 15 may be controlled by electric motors. More advantageously, resilient means may be provided to cause the flaps 15 to pivot into their deployed position while the tray is being lowered; in the raised position, the force of gravity overcomes the resilient return force and returns said flaps into their closed position.

In an advantageous variant of the invention, actuator means (not shown in the figures) may be provided so as to enable the collector tray 10 to pivot and/or move in translation towards the right or towards the left, when the tray is in its lowered position. This enables said tray to act like a snow plow to push an article that is too heavy or too large to be collected towards one side of the roadway.

Control means for the various actuators of the device 1 (actuators 12, electric motor of the brushing roll 16, actuators for the flaps 15, etc.) are provided inside the van 4, in a position that is accessible to the driver and/or a passenger.

For reasons of safety, the van 4 is preferably fitted with signaling lights such as arrows, a panel with a variable message, a rotating light.

The device of the invention is described in association with a vehicle of the van type; nevertheless, that is not any kind of limitation. Such a device could be mounted on a lighter vehicle such as car, or on the contrary on a heavy goods vehicle.

The collector tray shown in the figures is of a width that is narrower than the width of the vehicle, so as to avoid hiding its headlights when in the raised position. Once more, this limitation is not in any way central, and the tray could present a width that is equal to or even greater than the width of the vehicle. Under such circumstances, the flaps 15 may be omitted.

Tests have been performed, and they show that the device of the invention is capable of collecting articles of large dimensions such as truck exhausts, in a manner that is very reliable and at a speed of 50 km/h to 60 km/h.

1. A device for collecting articles on a roadway, the device comprising a collector tray, fastener means for fastening said tray to a land motor vehicle, and actuator means for causing said tray to move from a non-operational, raised position to a collecting, lowered position, and vice versa, the device being characterized in that:
said fastener means are adapted to enable said collector tray to be fastened directly to the front of a land motor vehicle; and in that
said actuator means are adapted to cause said collector tray to pivot between said raised position in which it is oriented perpendicularly to the surface of the roadway, and said lowered position in which it is substantially parallel to the surface of the roadway.

2. A device for collecting articles on a roadway according to claim 1, the device also including a detector for measuring the distance between the collector tray and the roadway, and a servo-control system for maintaining said distance constant when the tray is in its collecting, lowered position.

3. A device for collecting articles on a roadway according to claim 1, wherein said collector tray includes at least one wheel for coming into contact with the roadway when the tray is in its collecting, lowered position.

4. A device for collecting articles on a roadway according to claim 1, wherein said collector tray is arranged in such a manner that when it is in its operating, lowered position, at least a front portion of its bottom rubs against the roadway.

5. A device for collecting articles on a roadway according to claim 1, wherein the collector tray includes at least two flaps forming a funnel for guiding articles to be collected towards the inside of said tray.

6. A device for collecting articles on a roadway according to claim 5, wherein said flaps are pivotally mounted to pass from a folded position when the collector tray is in its non-operational, raised position, to an unfolded position when the collector tray is in its collecting, lowered position.

7. A device for collecting articles on a roadway according to claim 1, wherein the collector tray is fitted with a brushing roll fastened to its top portion.

8. A device for collecting articles on a roadway according to claim 1, wherein the collector tray is fitted with at least one abutment situated in its front portion, and pivotally mounted in such a manner as to enable an article to enter into the tray but to prevent it from leaving the tray accidentally.

9. A device for collecting articles on a roadway according to claim 1, the device also including second actuator means adapted to enable the collector tray to pivot and/or move sideways in translation when it is in its collecting, lowered position.

10. A device for collecting articles on a roadway according to claim 1, wherein the collector tray is provided with means for absorbing the kinetic energy of collected articles and for preventing them from being expelled from said tray.

11. A device for collecting articles on a roadway according to claim 1, wherein the collector tray is provided with a top closure element.

12. A device for collecting articles on a roadway according to claim 11, wherein said top closure element is mounted to move in translation on the collector tray in such a manner as to approach the bottom of said tray as it passes into its raised position and to move away from said bottom as the tray passes into its lowered position.

13. A land motor vehicle of the van type including a device for collecting articles on a roadway according to claim 1, together with control means for controlling the actuators of said device.

14. A land motor vehicle according to claim 13, wherein the article collector tray is fastened between the headlights of the vehicle in such a manner as to be positioned in front of the radiator grille of the vehicle when in its raised position.
